(19) United States
(12) Patent Application Publication
(10) Pub. No.: US 2006/0129948 A1
(43) Pub. Date: Jun. 15, 2006

(54) Method, system and program product for a window level security screen-saver

(76) Inventors: Mark Joseph Hamzy, Round Rock, TX (US); Dustin Kirkland, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/011,342

(22) Filed: Dec. 14, 2004

(51) Int. Cl. G06F 17/00

(52) U.S. Cl. 715/790

(57) ABSTRACT

Screensaver functionality is provided at the individual window level. A windows security module monitors the windows displayed by the computer to detect when a window becomes inactive in the display, for example by the user clicking and working within another window in the display. Upon becoming inactive, the windows security module overrides the application data being sent to a secured window and displays a predetermined screensaver-type image in its place, thereby hiding sensitive information from being displayed by the window during periods of inactivity. The windows security module can implement any user selected security type to hide or obscure the windows content such as blanking the individual window, displaying a text message or other graphic in the window, or minimizing the individual window upon becoming inactive. A time delay can also be set to delay the assertion of the security feature until a specified time following the window becoming inactive.

### BACKGROUND OF THE INVENTION

1. Field of the Invention

The present invention relates generally to information processing systems, and more particularly to a methodology and system for providing a screen-saver technique for obscuring sensitive or confidential information on a computer display.

2. Background of the Invention

Computer desktop environments of all major operating systems support multi-threaded processing and multiple window displays. Separate running computer processes or applications are represented by graphical interfaces in separate desktop windows. Many users try to maximize their usable display space by using large monitors or possibly using multiple monitors to display multiple overlapping windows on the display.

A screensaver for a computer work station provides a computer user with the means of manually or automatically obscuring the display when the computer user is either absent or inactive at the work station for some period of time. In operation, the screensaver blanks the display or presents an attractive pattern or image, which is usually repetitively displayed until the user engages the computer. Although screensaver functions are successful in obscuring the entire display, most screensavers are usually invoked only after a few minutes of keyboard or mouse inactivity on the computer system. There are periods during which the user is interacting with one window, while other windows of sensitive information are simultaneously fully or partially displayed on the computer. There are also periods of inactivity on a computer system prior to the screensaver activation during which sensitive information is displayed on the inactive computer. It can be seen that there is a need for a system and method to protect the display of windows or segments of windows on a screen during periods where the user is not interacting with the particular window displaying the sensitive information and prior to the screensaver function turns on.

### SUMMARY OF THE INVENTION

In accordance with the present invention, improved methods, systems and articles of manufacture for windows security in a data processing system are disclosed. In one embodiment of the present invention, a windows security module displays first images generated from data sent by a first process for display within a first window frame of an active window displayed within a graphical user interface. The windows security module also automatically secures second images generated from data sent by a second process for display within a second window frame of an inactive window displayed within the windowing graphical user interface such that the second images are automatically obscured from view in the inactive window in response to the window becoming inactive.

All objects, features, and advantages of the present invention will become apparent in the following detailed written description.

### BRIEF DESCRIPTION OF THE DRAWINGS

This invention is described in a preferred embodiment in the following description with reference to the drawings, in which like numbers represent the same or similar elements, as follows:

FIG. 1 is a block diagram of a general-purpose computer system to which the present invention may be applied.

FIG. 2 is a block diagram of major components of the general-purpose computer system shown in FIG. 1.

FIG. 3 shows a functional block diagram of a user interface system implemented as a part of or in conjunction with the software operating environment within a exemplary system, in accordance with a preferred embodiment.

FIG. 4 shows an exemplary Table of All Windows, in accordance with a preferred embodiment.

FIG. 5 shows an exemplary screen display resulting from the Table of All Windows, in accordance with a preferred embodiment.

FIG. 6 shows an exemplary screen display of an individual window option screen, called “Create Windows Display Security Settings”, in accordance with a preferred embodiment.

FIG. 7 shows an exemplary table of windows display security settings, in accordance with a preferred embodiment.

FIG. 8 shows an exemplary screen shot of a display implementing the security function for an inactive window, in accordance with a preferred embodiment of the present invention.

FIG. 9 shows a flow diagram of an exemplary process used to initiate and set up the display security features of a preferred embodiment of the present invention.

FIG. 10 shows a flow diagram of a process for providing individual window security by obscuring display content in an inactive window, in accordance with the preferred embodiment of the present invention.

### DETAILED DESCRIPTION OF PREFERRED EMBODIMENTS

A preferred embodiment provides a screensaver functionality at the individual window level. A windows security module monitors the windows displayed by the computer to detect when a window becomes inactive in the display, for example by the user clicking and working within another window in the display. Upon becoming inactive, the windows security module overrides the application data being sent to a secured window and displays a predetermined screensaver-type image in its place, thereby hiding sensitive information from being displayed by the window during periods of inactivity. The windows security module can implement any user selected security type to hide or obscure the windows content such as blanking the individual window, displaying a text message or other graphic in the window, or minimizing the individual window upon becoming inactive. As an additional option, a time delay can also be set to delay the assertion of the security feature until a specified time following the window becoming inactive.

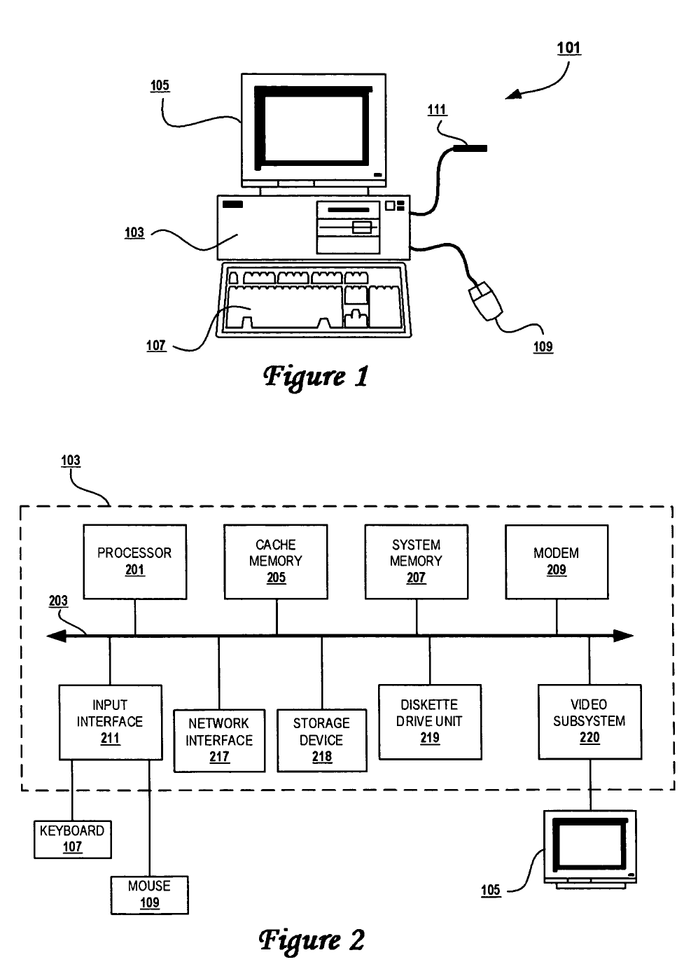

With reference now to the figures, and in particular with reference to FIG. 1, a computer system 101 includes a processor unit 103, which is typically arranged for housing a processor circuit along with other component devices and subsystems of the computer system 101. The computer system 101 also includes a monitor unit 105 (which may be a CRT, a liquid crystal display, flat panel or other display device), a keyboard 107 and a mouse or pointing device 109, which are all interconnected with the computer system illustrated. Also shown is a connector 111, which is arranged for connecting a modem or network card within the computer system to a communication line such as a telephone line, cable or other communication medium. The connector 111 may also be implemented in a cellular or other wireless network.

Several of the major components of the system 101 are illustrated in the block diagram of FIG. 2. A processor circuit 201 is connected to a system bus 203, which may be any host system bus. It is noted that the processing methodology disclosed herein will apply to many different bus and/or network configurations. A cache memory device 205 and a system memory unit 207 are also connected to the bus 203. A modem 209 is arranged for connection to a communication line, such as a telephone line, through a connector 111 (FIG. 1). The modem 209, in the present example, selectively enables the computer system 101 to establish a communication link and initiate communication with another computer system, or network or database server. Modem 209 may be an analog, Digital Subscriber Line or cable modem, for example.

The system bus 203 is also connected through an input interface circuit 211 to a keyboard 213 and a mouse or pointing device 215. The bus 203 is also coupled to a network interface subsystem 217 and a diskette drive unit 219. A video subsystem 220, which may include a graphics subsystem, is connected to a display device 221. A storage device 218, which may comprise a hard drive unit and/or an optical CD, is also coupled to the bus 203. The diskette drive unit provides a means by which individual diskette programs may be loaded on to the hard drive, or accessed directly, for selective execution by the computer system 101. As is well known, program diskettes containing application programs represented by magnetic indicia on the diskette, may be read from the diskette drive, and the computer system is selectively operable to read such magnetic indicia and create program signals. Such program signals are selectively effective to cause the computer system to present displays on the screen of a display device and respond to user inputs in accordance with the functional flow of the application program on the diskette.

In general, an implementing computer system may include a plurality of processors in a multi-bus system in a network of similar systems. However, since the workstation or computer system implementing the present invention in an exemplary embodiment is generally known in the art and composed of electronic components and circuits generally known to those skilled in the art, the computer system details beyond those shown in FIGS. 1 and 2 are not specified to any greater extent than that considered necessary as illustrated for the understanding and appreciation of the underlying concepts of the present invention and in order not to obfuscate or distract from the teachings of the present invention.

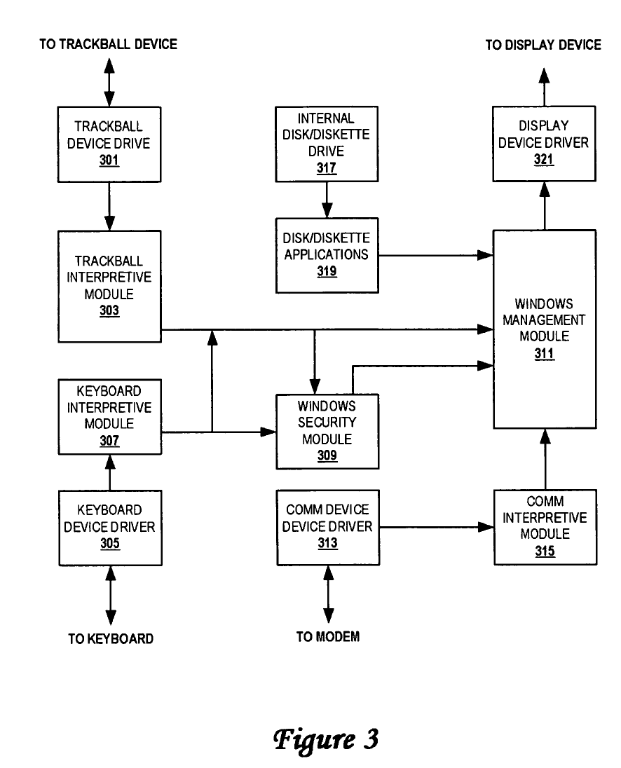

In FIG. 3, there is shown a functional block diagram of the user interface system implemented as a part of or in conjunction with the software operating environment within the exemplary system 101. As will be appreciated, while a software embodiment is disclosed, those skilled in the art will recognize that the functionality implemented by the user interface system can also be implemented through an entirely hardware environment of electronic components and circuits, or through a combination of hardware and software including components from both. In this exemplary software operating environment, one or more applications and software modules comprising the user interface system interact with various modules and components of what is known in the art as an operating system. In addition, the various modules and components of the operating system interface with each other. Finally, the modules, components and applications interface with hardware present on the computer system through what is known in the art as a device driver module and through an Original Equipment Manufacturer (OEM) adaptation layer. The specific device drivers, modules and applications identified in FIG. 3 control user interface devices in computer system 101. They are loaded into system/cache memory 205/207, executed by processor 201 and managed by the computer's operating system (not shown).

As illustrated in FIG. 3, the user interface software system includes a windows security module 309 for implementing the individual window security function as provided in an exemplary embodiment of the present invention. The user interface software system further includes a trackball device driver 301 coupled between a mouse trackball device (not shown) and a trackball interpretive module 303. The trackball device may be a movable mouse riding on a trackball or a stationary base unit for a trackball mounted on the base. The output of the trackball interpretive module 303 provides trackball input signals to windows security module (WSM) 309 and also to a windows management module (WMM) 311. The trackball input signals are representative of user inputs from the mouse/pointing device 109. The keyboard 107 is coupled through a keyboard device driver 305 and a keyboard interpretive module 307 to furnish inputs to WSM 309 and also directly to the WMM 311. A communication (COMM) device driver 313 couples the modem 209 to a COMM interpretive module 315 which, in turn, provides inputs to WMM 311. An internal disk or diskette drive 317 is operable to run disk and diskette applications 319 and provide application input to WMM 311. WSM 309 also applies additional inputs to the WMM 311. WMM 311 generates display graphics to a flat panel or other display device by providing input signals to a display device driver 321 connected to the display device in the exemplary illustration.

WMM 311 coordinates the screen data flow from the various devices and applications into an orderly presentation of windowed information on the display device 221. Commands issued by WSM 309 override display commands from applications 319 issued to WMM 311 and generate an identified screensaver display for specified windows in the display, in accordance with the preferred embodiment of the present invention. When a “screensaver” function is invoked, some of the devices that interface with WMM 311 are masked off by the locking functions of WSM 309. Other devices may continue to function and therefore continue to update window images even though the screen is “locked”. The operation of WSM 309 is described in more detail below.

WMM 311 has many internal subroutines to accomplish its overall function. As part of integrating keyboard, mouse, and modem (e.g. Internet) input, WMM 311 must serve as the window manager for the system and handle window creation, window movement, window iconization, window resizing, window z-ordering and “bring-window-into-focus” (i.e., make it active), amongst many other functions. In order to manage these windows efficiently, it is necessary for WMM 311 to maintain a database, called a “Table of All Windows,” identifying all windows displayed or “inconified” for a particular session.

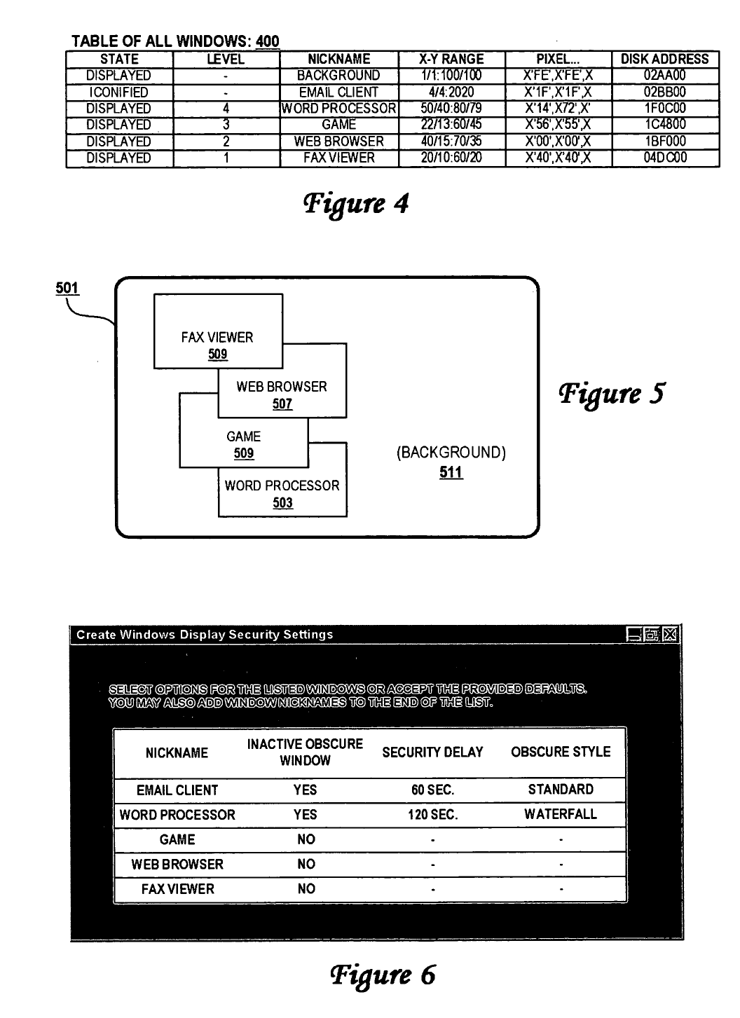

As shown in FIG. 4, a table 400 is an exemplary Table of All Windows for the computer. Table 400 is managed by a windows manager running on top of or as part of the operating system, and contains information about the contents of each window present in the display, including information regarding the nickname, z-order and the X-Y limits of the pixels of each window as it exists in the display. Each entry for a window also contains an identifier or “nickname” for the window, which is usually the same or similar to the identifier or “nickname” commonly seen in the activate button or “pull-down bar” for a window. The user also can cause the X-Y coordinates of each window within the display to change by moving or resizing windows about the screen. Software functions that create or modify the content of each window (such as applications executing in the computer system) create or modify the display values of the actual pixels identified in the table 400. In order to correctly perform this function, these software functions must always first obtain the X-Y coordinate data from table 400. From these X-Y coordinates, the height and width of the window can be derived. Although an actual table is far more complex, for this example, the screen is depicted as a 100×100 matrix. The last column of each entry for a window is the disk location of the last saved copy of the window

The table entries in FIG. 4 would result in the exemplary screen display shown in FIG. 5. As the highest level z-order (i.e. “1” in the exemplary table 400), the “Fax” window 509 is displayed on top of all other windows. The order of display for the other windows is also determined by their z-order, except for minimized applications (for example, the email application is currently minimized) and is shown as an Icon or other graphic element (not shown) instead of as a separate window in the display. The user can change the z-ordering and the X-Y coordinates of any entry by taking actions like mouse clicking or window “drag” and “resize” functions. Table 400 always contains one default entry that describes the background layer for the entire screen display and is always locked at the bottom of the z-ordering by WMM 311. All active windows are displayed above the background in the user's display, even when the background is brought into focus (i.e., active) by the user clicking on the background.

An exemplary screen display of an individual window option screen, called “Create Windows Display Security Settings”, is illustrated in FIG. 6. This option screen allows the user to select the security options for specified windows when inactive on the display. The options identify which windows are to be obscured by use of a screensaver type functionality when not the active window in the display. The options further specify a delay following inactivation before the window is obscured, and the stylized or standard treatment to be given to the secured display.

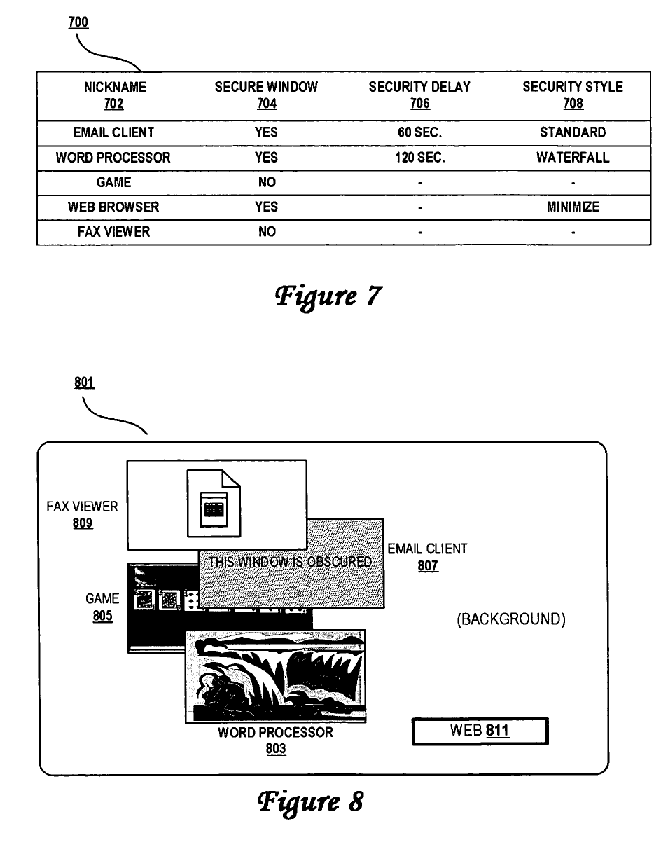

After being set in the screen of FIG. 6, the user options are saved as windows display security settings in a table 700, as seen in FIG. 7. Table 700 need only be created once by the user, but may be updated whenever the user sees fit. When creating table 700 from the settings screen in FIG. 6, the user may also specify application “nicknames” in column 702 for applications not currently being displayed on the screen. Later activation of those applications within the operating system will load the window's data into table 400 and allow processing of the window by WSM 309 when the matching entry in table 400 goes inactive.

The operation of WSM 309 is now described. When windows are being displayed in the display 501 (FIG. 5), WSM 309 continuously monitors the list of windows in table 400 (FIG. 4) for a change in the z-ordering of the windows. WSM 309 implements the options set in table 700 for each displayed window's obscure options by issuing instructions to WMM 311. If a new window comes into focus by user action (for example, clicking in the window), it is set at the top level of the z-ordering (level 1) by WMM 311, and WSM 309 issues instructions to WMM 311 to turn off any security function specified by windows security options 700 that is obscuring the display of the new top level window. For example, as seen in FIG. 5, window 509 containing the “fax” is set at the top level and its content is actively displayed on display 501 without any screensaver function. All displayed windows set at level 2 and greater in table 400, for example windows 503, 505, 507 in FIG. 5, are not currently in focus or active on the display 105.

Upon detecting a window in the display becoming inactive and dropping from the top level in the z-order specified in table 400, WSM 309 identifies the nickname of the process running in the detected window and determines if that process has a “Secure Window” setting option set to “YES” in column 704. If so, any window listed in table 400 displaying data generated from the identified process (nickname 702) is to be secured by WSM 309 upon becoming inactive. Methods of securing an inactivated window by WSM 309 in accordance with alternative preferred embodiments of the present invention include (1) displaying a screen-saver-type static or dynamic image in place of the application data of the inactive window or within a viewable sector of the inactive window, (2) blanking the display within the inactive window, or (3) automatically minimizing an inactivated window.

Prior to securing an inactivated window, WSM 309 determines if a security delay 706 has been set for the process 702 executing in the inactivated window. If so, WSM 309 allows WMM 311 to continue displaying the window's active content requested by the executing process for a period equal to the specified security delay (for example in seconds) following the time when the window enters the inactive state. For example, table 700 specifies at column 706 that the content of the window containing the “Email Client” shall remain on screen for sixty seconds following that window becoming inactive on the display. Column 706 specifies that the content in the “Word Processor” window shall remain on screen for one hundred and twenty seconds following that window becoming inactive. Column 706 specifies that the content in the “Web Browser” window shall not remain on screen following that window becoming inactive.

Upon expiration of any security delay, WSM 309 sends instructions to WMM 311 to implement a security function within the indicated window as specified at column 708. In response, WMM 311 requires the display device driver 321 to generate a predetermined content at the pixels of the display identified in table 400 for the inactive window, instead of the content being driven by the window's application 319. The security style 708 sets the predetermined content that will be specified by WSM 309 for display on display 105. For example, the “standard” security style specified in table 700 could be a standard printed text message (“THIS WINDOW IS OBSURED”) indicating that the content of that window has been obscured or could comprise blanking the pixel display within the window frame of the inactive window. As another example, the “waterfall” security style is a picture or dynamic video image similar to a standard “screensaver” present on most computer systems. In an alternative response, WMM 311 requires the display device driver 321 to “minimize” the inactive window by replacing it with a small icon (for example in a task bar) or completely removing it from the display.

FIG. 8 shows an exemplary screen shot of display 501 implementing the security function for an inactive window, in accordance with a preferred embodiment of the present invention. As seen in the example of FIG. 8, fax window 809 is in focus (active) and displays the fax content within the fax viewer application. Window 807 contains the email client application and is inactive at level 2. (FIG. 4). Following the sixty second delay period set at column 706, window 807 has been set to the “standard” obscure style, in accordance with the options set at column 708 in table 700. In this example, the “standard” style displays text stating “THIS WINDOW IS OBSCURED”. The game application in window 805 is not set to obscure its inactive window at column 704. Consequently, window 805 continues to display the application's display content, even though out-of-focus (inactive). Following the one hundred and twenty second delay period set at column 706, the word processor application in window 803 has been set to the “waterfall” security style, in accordance with the option set at column 708 in table 700. As specified at column 708, Window 803 displays the “waterfall” obscure style, which is a picture of a waterfall in this example, instead of the word processing application's data content. As shown in FIG. 8, the web browser application window has been minimized to a small rectangular icon at the bottom of display 801 in response to inactivation (as indicated by level 2 in Table 400) as specified by security style 708.

As will be appreciated, other obscure styles could be utilized by the system of the preferred embodiment. Other security styles include merely blanking the inactive window or displaying a facade image appearing to be a window generated by the applicable application but containing non-sensitive or non-confidential information in place of the actual application content. For example, a “dummy” email could be created by the user and stored in memory accessible by WSM 309 for display in window 807 when the inactive window security function is implemented. In this embodiment, this “dummy” obscure style is accessed by WMM 311 and displayed in the inactive email client window, instead of the actual data content currently loaded and being displayed by the email client application. In an alternative embodiment, only a portion of the inactive window is obscured by the replacement image, for example a viewable sector containing confidential information, while leaving other viewable sectors of the inactive window unobscured and displaying application data.

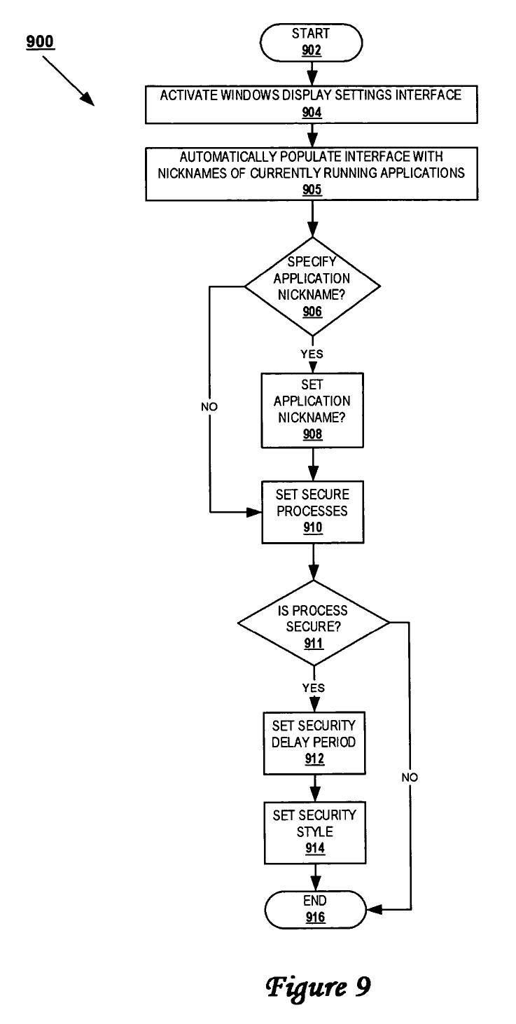

With reference now to FIG. 9, there is shown a flow diagram of an exemplary process used to initiate and set up the display security features of a preferred embodiment of the present invention. The process 900 starts at step 902 and proceeds to step 904 when the windows display security settings interface (FIG. 6) to WSM 309 is activated. Thereafter, at step 905, WSM 309 automatically creates and fills in the process or application nickname 702 for each display window currently being generated in the system, as indicated in the table of windows (table 400). At decision 906, it is determined if the user elects to enter additional nicknames for other applications that may be run within the system in the future. If so, the application nickname is entered at step 908 (column 702). Thereafter, at step 910, selected processes are set in table 700 as requiring a “secure window” (column 702) such that the processes display content is obscured by the window security function when its window becomes inactive. At step 911, processes set as secure processes are passed to step 912, where the security delay period is set to indicate the number of seconds following inactivation of the application's window that the security application obscures the window's content (column 706). The security style for the application is set at step 914 (column 708), and specifies how WSM 309 obscures the window's content such as by blanking the content or overlaying the window with a “screensaver” type picture unrelated to the application content. Thereafter, the process ends at step 916.

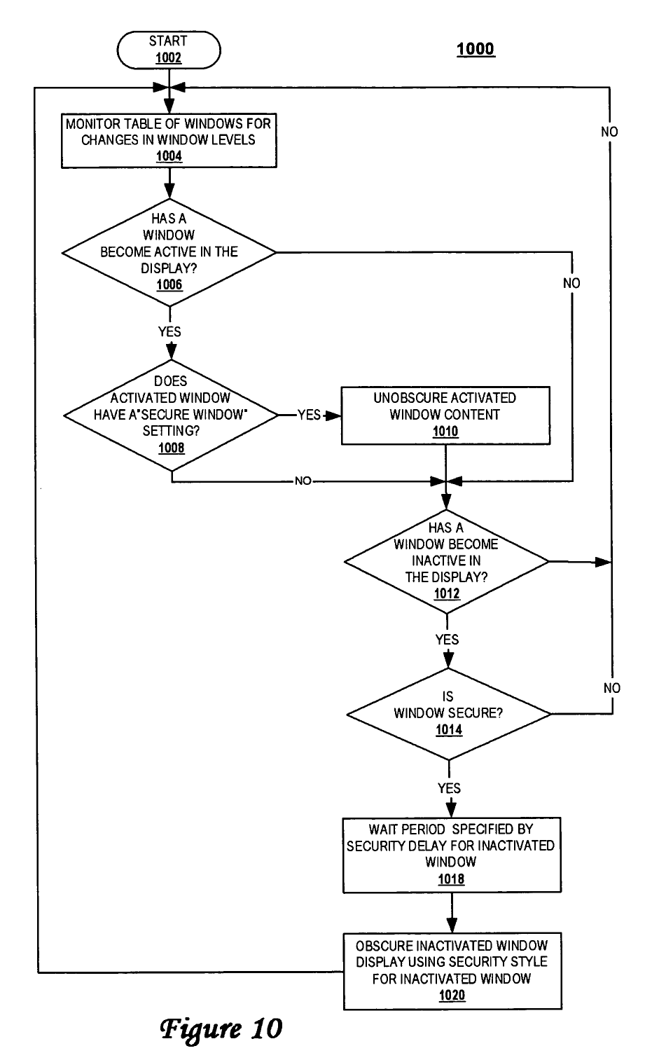

FIG. 10 shows a flow diagram of a process for providing individual window security by obscuring display content in an inactive window, in accordance with the preferred embodiment of the present invention. Process 1000 starts at step 1002 and proceeds to step 1004, where WSM 309 monitors the Table of Windows (table 400) to detect a change in any window's activity or status. In particular, WSM 309 monitors whether a window is active or inactive in the display, for example, as indicated by its z-order. Then, at step 1006, WSM 309 determines if a window has become active in the display.

When the determination at decision 1006 is that a window has become active (i.e., set to the top level or level 1, as shown in FIG. 4), the process proceeds to decision block 1008 where WSM 309 accesses table 700 to determine if the process associated with the activated window has an “secure window” setting (column 704). If it is determined at decision block 1008 that the activated window is secure, and therefore had been obscured during its inactive state, the process proceeds to step 1010 where WSM 309 issues commands to WMM 311 to unobscure the data content contained within the activated window by turning off any security style that had been applied to the inactive window. Thereafter, or in the event the window had not been obscured in its inactive state, the process proceeds to decision block 1012.

At step 1012, WSM 309 determines if a window has become inactive (out-of-focus) in the display, as detected by a window changing from a level 1 to a greater level display. In a preferred embodiment, WSM 309 considers a window inactive if it is not currently the window “in focus” on the windows desktop (as selected by the user's pointing device or other user interface) or if a pre-selected period of time has elapsed since the last received user input from trackball device driver 301 or keyboard device driver 305. If so, process 1000 proceeds to step 1014, where WSM 309 determines if the inactivated window is set as a secure window, as set at column 704. If not, the process returns to step 1004 to continue monitoring the table 400 for changes in the active/inactive status of windows in the display.

If set as a secure window (704), the process proceeds to step 1018 to wait the period specified by security delay setting 706 in table 700, while continuing to monitor the other windows in table 400. Upon the expiration of the security delay, process 1000 proceeds to step 1020, where WSM 309 obscures the inactivated window display by superimposing the security style 708 within pixel boundaries of the inactivated window, thereby obscuring the image data generated by the window's application. In particular, WSM 309 instructs WMM 311 to override any image data input from applications 319 and generate images identified by the inactivated process' security style 708 at the pixels specified for the inactivated window in table 400. After securing the inactivated window, process 1000 returns to step 1004 to continue monitoring table 400 for additional changes in the window levels specified therein.

Note that the background or desktop level of the windowing system presents a special case for the processing of the preferred embodiment. This results in the preferred embodiment of process 1000, which continues to monitor for both the activation and inactivation of windows (steps 1006 and 1012) because there are cases where one may occur without the other. In particular, if the user selects the background of the display instead of one of the windows running in the system, the background is set to level 1 in the table 400. In that case, while one window has become inactive in the display, another window has not simultaneously become active. Conversely, if when the background is active the user selects a window in the display via a user interface, the window becomes active in the display but no other window specified in the table 400 simultaneously becomes inactive. In an alternative embodiment of the present invention, the background of the display can be also be treated as a window by WSM 309 and designated window security settings 704, 706, 708.

While the invention has been particularly shown and described with reference to a preferred embodiment, it will be understood by those skilled in the art that various changes in form and detail may be made therein without departing from the spirit and scope of the invention. For example, the present invention may be implemented using any combination of computer programming software, firmware or hardware. As a preparatory step to practicing the invention or constructing an apparatus according to the invention, the computer programming code (whether software or firmware) according to the invention will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the computer programming code is used by either executing the code directly from the storage device, by copying the code from the storage device into another storage device such as a hard disk, RAM, etc., or by transmitting the code for remote execution. The method form of the invention may be practiced by combining one or more machine-readable storage devices containing the code according to the present invention with appropriate standard computer hardware to execute the code contained therein. An apparatus for practicing the invention could be one or more computers and storage systems containing or having network access to computer program(s) coded in accordance with the invention. While this invention is described in terms of the best mode for achieving this invention's objectives, it will be appreciated by those skilled in the art that variations may be accomplished in view of these teachings without deviating from the spirit or scope of the present invention.

What is claimed is:

1. A method for providing window security in a data processing system comprising:
displaying one or more first images generated from data sent by a first process for display within a first window frame of an active window displayed within a graphical user interface; and
automatically securing one or more second images generated from data sent by a second process for display within a second window frame of an inactive window displayed within the graphical user interface such that the second images are automatically obscured from view in the inactive window by substituting the second images with one or more third images in response to the window becoming inactive, wherein the third images are not the first images.

2. The method according to claim 1, wherein the third images are pre-selected text.

3. The method according to claim 1, wherein the second images are obscured by automatically minimizing the inactive window in response to the window becoming inactive.

4. The method according to claim 1, further comprising displaying the second images in response to the second window frame becoming an active window.

5. The method according to claim 1, further comprising obscuring the first images upon the second window frame becoming an active window.

6. The method according to claim 1, wherein a window frame becomes an active window upon selection via a user interface.

7. The method according to claim 1, wherein an inactive window is determined based on its order within a z-ordered window management scheme.

8. The method according to claim 1, wherein the second images are obscured after a predetermined delay following the second window frame becoming an inactive window.

9. The method according to claim 1, wherein the first images are generated from data sent by the operating system for display as a background image in the display.

10. The method according to claim 1, further comprising determining, before obscuring the second images, that a setting indicates images generated from data sent by the second process for display should be obscured within an inactive window frame.

11. A method for displaying windows in a data processing system comprising:
displaying image data from an application within an associated active window in a display; and
displaying preselected image data in a viewable sector of an inactive window being displayed in conjunction with the active window in the display without obstructing images within the active window, such that the preselected image data prevents at least a portion of image data generated for the viewable sector from being displayed by an application associated with the inactive window.

12. The method according to claim 11, wherein an active window is determined based upon user input.

13. The method according to claim 11, wherein an inactive window is determined based on its order within a z-ordered window management scheme.

14. The method according to claim 11, wherein the preselected image data is displayed after a predetermined delay following the inactive window being inactivated.

15. The method according to claim 11, wherein the preselected image data creates a blank screen in the viewable sector.

16. The method according to claim 11, wherein the preselected image data creates text on the display.

17. The method according to claim 11, further comprising displaying image data from another application within an additional inactive window in the display, in conjunction with the active window and the inactive window.

18. A system for displaying windows comprising:
means for displaying image data from an application within an associated active window in a display; and
means for displaying preselected image data in a viewable sector of an inactive window being displayed in conjunction with the active window in the display without obstructing images within the active window, such that the preselected image data prevents at least a portion of image data generated for the viewable sector from being displayed by an application associated with the inactive window.

19. The system according to claim 18, wherein an inactive window is determined based on its order within a z-ordered window management scheme.

20. The system according to claim 18, wherein the preselected image data is displayed after a predetermined delay following the inactive window being inactivated.

21. An article of manufacture comprising machine-readable medium including program logic embedded therein for displaying windows in a data processing system that causes control circuitry in a data processing system to perform the steps of:
displaying image data from an application within an associated active window in a display; and
displaying preselected image data in a viewable sector of an inactive window being displayed in conjunction with the active window in the display without obstructing images within the active window, such that the preselected image data prevents at least a portion of image data generated for the viewable sector by an application associated with the inactive window from being displayed.

22. The article of manufacture of claim 21, wherein an inactive window is determined based on its order within a z-ordered window management scheme.

23. The article of manufacture of claim 21, wherein the preselected image data is displayed after a predetermined delay following the inactive window being inactivated.

24. A method for displaying windows in a data processing system comprising:
associating a separate screen saver image with each window displayed by the data processing system;
determining if a given window displayed by the data processing system becomes inactive; and
displaying the associated screen saver image within an inactive window in the data processing system.

25. The method according to claim 24, wherein the separate screen saver image is user specifiable.

26. The method according to claim 24, wherein the given window is determined to be inactive based upon user interaction.

27. The method according to claim 24, wherein the associated screen saver image is displayed after a predetermined time period has elapsed since the inactive window has been determined to be inactive.

28. A system for displaying windows in a data processing system comprising:
means for associating a separate screen saver image with each window displayed by the data processing system;
means for determining if a given window displayed by the data processing system becomes inactive; and
means for displaying the associated screen saver image within an inactive window in the data processing system.

29. The system according to claim 28, wherein the separate screen saver image is user specifiable.

30. The system according to claim 28, wherein the given window is determined to be inactive based upon user interaction.

31. The system according to claim 28, wherein the associated screen saver image is displayed after a predetermined time period has elapsed since the inactive window has been determined to be inactive.

32. An article of manufacture comprising machine-readable medium including program logic embedded therein for displaying windows in a data processing system that causes control circuitry in a data processing system to perform the steps of:
associating a separate screen saver image with each window displayed by the data processing system;
determining if a given window displayed by the data processing system becomes inactive; and
displaying the associated screen saver image within an inactive window in the data processing system.

33. The article of manufacture according to claim 32, wherein the separate screen saver image is user specifiable.

34. The article of manufacture according to claim 32, wherein the given window is determined to be inactive based upon user interaction.

35. The article of manufacture according to claim 32, wherein the associated screen saver image is displayed after a predetermined time period has elapsed since the inactive window has been determined to be inactive.
